(19) United States
(12) Patent Application Publication
(10) Pub. No.: US 2016/0267189 A1
(43) Pub. Date: Sep. 15, 2016

(54) METHOD FOR PERFORMING NETWORK SEARCH AT A BROWSER SIDE AND A BROWSER

(71) Applicants: BEIJING QIHOO TECHNOLOGY COMPANY LIMITED, Beijing (CN); QIZHI SOFTWARE (BEIJING) COMPANY LIMITED, Chaoyang District, Beijing (CN)

(72) Inventors: Yufeng MI, Beijing (CN); Lin LI, Beijing (CN); Huan REN, Beijing (CN)

(21) Appl. No.: 15/036,184

(22) PCT Filed: Sep. 24, 2014
(86) PCT No.: PCT/CN2014/087294

§ 371 Date: May 12, 2016

(30) Foreign Application Priority Data
Nov. 15, 2013 (CN) 201310575143.0

(51) Int. Cl. G06F 17/30

(52) U.S. Cl. CPC G06F 17/30867; G06F 17/30598; G06F 17/30684

(57) ABSTRACT

The invention provides a method for performing network search at a browser side and a browser. The method for performing network search at a browser side comprises the following steps: acquiring a selected webpage element in a webpage; picking out a text element in the selected webpage element; acquiring a search category corresponding to the text element; and initiating a search request to a search engine interface corresponding to the search category, and displaying a search result returned by the search engine interface at the browser side. By utilizing the technical solution of the invention, the search category is determined according to the text content in the selected webpage element, the search result displayed in the browser matches the search category needed by a user, thereby, the search result which more meets the user's expectations is obtained, intervention of the search procedure by the user is reduced, and the efficiency of the search operation performed by the user when browsing a webpage is improved.

### FIELD OF THE INVENTION

The invention relates to the field of internet, and in particular, to a method for performing network search at a browser side and a browser.

### BACKGROUND OF THE INVENTION

Traditional network search methods lie in that, a user opens a page of a search engine, enters a keyword in an input box or other interface in the page and initiates search, and then the search result is loaded in a page of a website of the search engine.

By utilizing a traditional search method, when a user needs to search a text of a webpage when browsing the webpage, the first copies the corresponding text, then opens a page of a search engine and enters the text, so as to be able to perform search. The operation steps of the user are relatively complex.

In addition, there is further a search method in the prior art, in which a user selects part of words from the content currently browsed, a quick search button will appear in the browser, and after the user clicks the button, it may jump to a search result page of the search engine according to the selected words, and the search result page will be exhibited in a new page.

FIG. 1 and FIG. 2 show two effect drawings of a browser launching webpage quick search in the prior art, respectively. As shown in the figures, after a user selects a text, once a preset condition is satisfied, for example, a mouse stays at the selected word for a predetermined time, or the like, a quick search button will be displayed at the selected word, so that the user operates. However, existing zoned word quick search lies in, based on word information obtained after the selection, producing a pre-configured entry option, directly loading an icon of the entry and generating a corresponding uniform resource locator (URL for short). In such a mode, the entry of the search is fixed, and much search content that the user does not need, which can not meet the requirements of targeted search of the user. In addition, after the user clicks the button, the page directly jumps to the label of the search result, which interrupts the user's browsing in the original page.

### SUMMARY OF THE INVENTION

In view of the above problems, the invention is proposed to provide a browser and a corresponding method for performing network search at a browser side, which overcome the above problems or at least in part solve the above problems.

According to an aspect of the invention, there is provided a method for performing network search at a browser side and a browser. The method for performing network search at a browser side comprises the following steps: acquiring a selected webpage element in a webpage; picking out a text element in the selected webpage element; acquiring a search category corresponding to the text element; and initiating a search request to a search engine interface corresponding to the search category, and displaying a search result returned by the search engine interface at the browser side.

Optionally, the acquiring a search category corresponding to the text element comprises: counting frequencies of use of various search categories of a browser, and taking a search category of which the frequency of use is ranked higher as a search category corresponding to the text element.

Optionally, the acquiring a search category corresponding to the text element comprises: extracting text content in the text element; performing search keywords matching on the text content, wherein the search keywords are vocabularies categorized according to search categories which are preset at the browser side; and taking a search category corresponding to a matched search keyword as a search category corresponding to the text element.

Optionally, the acquiring a search category corresponding to the text element comprises: acquiring webpage information of the webpage, the webpage information comprising any one or more of the following: a uniform resource locator of the webpage, a title of an article which the text element belongs to, context content of the text element, and a user tag of a user of the webpage; and determining a search category corresponding to the text element according to the webpage information.

Optionally, the determining a search category corresponding to the text element according to the webpage information comprises: determining a content type of the webpage according to the uniform resource locator of the webpage, and determining a search category corresponding to the text element according to the content type of the webpage in combination with the title of the article and the context content.

Optionally, the determining a search category corresponding to the text element according to the webpage information comprises: performing matching calculation to obtain individual corresponding search categories according to the text content of the text element, the content type of the webpage, and the user tag, respectively; setting information weights for calculation for the text content, the webpage information and the user tag, respectively; and performing weighted calculation on the search categories obtained by the matching calculation according to the information weights, to obtain a search category corresponding to the text element.

Optionally, the initiating a search request to a search engine interface corresponding to the search category comprises: performing word segmentation processing on the text element to obtain one or more search field; and sending the one or more search field to a search engine interface corresponding to the search category.

Optionally, the displaying a search result returned by the search engine interface at the browser side comprises: generating in the webpage a floating layer for exhibiting a search result, and loading the search result in the floating layer.

In particular, the invention further provides a browser. The browser comprises: a webpage element acquisition module configured to acquire a selected webpage element in a webpage; a text element acquisition module configured to pick out a text element in the selected webpage element; a categorization module configured to acquire a search category corresponding to the text element; and a search module configured to initiate a search request to a search engine interface corresponding to the search category, and display a search result returned by the search engine interface at the browser side.

Optionally, the categorization module is configured to count frequencies of use of various search categories of a browser, and take a search category of which the frequency of use is ranked higher as a search category corresponding to the text element.

Optionally, the categorization module is configured to extract text content in the text element; perform search keywords matching on the text content, wherein the search keywords are vocabularies categorized according to search categories which are preset at the browser side; and take a search category corresponding to a matched search keyword as a search category corresponding to the text element.

Optionally, the categorization module comprises: a webpage information acquisition sub-module configured to acquire webpage information of the webpage, the webpage information comprising any one or more of the following: a uniform resource locator of the webpage, a title of an article which the text element belongs to, context content of the text element, and a user tag of a user of the webpage; and a category matching sub-module configured to determine a search category corresponding to the text element according to the webpage information.

Optionally, the category matching sub-module is configured to determine a content type of the webpage according to the uniform resource locator of the webpage, and determine a search category corresponding to the text element according to the content type of the webpage in combination with the title of the article and the context content.

Optionally, the category matching sub-module is configured to perform matching calculation to obtain individual corresponding search categories according to the text content of the text element, the content type of the webpage, and the user tag, respectively; set information weights for calculation for the text content, the webpage information and the user tag, respectively; and perform weighted calculation on the search categories obtained by the matching calculation according to the information weights, to obtain a search category corresponding to the text element.

Optionally, the search module is configured to perform word segmentation processing on the text element to obtain one or more search field; send the one or more search field to a search engine interface corresponding to the search category; and generate in the webpage a floating layer for exhibiting a search result, and load the search result in the floating layer.

According to yet another aspect of the invention, there is provided a computer program comprising a computer readable code which causes a computing device to perform any of the methods for performing network search at a browser side described above, when said computer readable code is running on the computing device.

According to still another aspect of the invention, there is provided a computer readable medium storing therein the computer program as described above.

In the method for performing network search and the browser of the invention, the search category is determined according to the text content in the selected webpage element, the search result displayed in the browser matches the search category needed by a user, thereby, the search result which more meets the user's expectations is obtained, intervention of the search procedure by the user is reduced, and the efficiency of the search operation performed by the user when browsing a webpage is improved.

Further, in the invention, an exhibition floating layer categorized according to the search category is generated in the page, and the search result is loaded in the floating layer, which can perform display according to an accurate categorization, facilitates the user to quickly obtain the search result, and does not affect the user's browsing the original page.

The above description is merely an overview of the technical solutions of the invention. In the following particular embodiments of the invention will be illustrated in order that the technical means of the invention can be more clearly understood and thus may be embodied according to the content of the specification, and that the foregoing and other objects, features and advantages of the invention can be more apparent.

### BRIEF DESCRIPTION OF THE DRAWINGS

Various other advantages and benefits will become apparent to those of ordinary skills in the art by reading the following detailed description of the preferred embodiments. The drawings are only for the purpose of showing the preferred embodiments, and are not considered to be limiting to the invention. And throughout the drawings, like reference signs are used to denote like components. In the drawings:

FIG. 1 shows a first effect drawing of a browser launching webpage quick search in the prior art;

FIG. 2 shows a second effect drawing of a browser launching webpage quick search in the prior art;

FIG. 3 is a schematic diagram of a browser according to an embodiment of the invention;

FIG. 4 is a schematic diagram of a method for performing network search at a browser side according to an embodiment of the invention;

FIG. 5 is a flow block diagram of utilizing webpage information to determine a search category in a method for performing network search at a browser side according to an embodiment of the invention;

FIG. 6 is a first effect drawing in which a search result is exhibited in a floating layer in a method for performing network search at a browser side according to an embodiment of the invention;

FIG. 7 is a second effect drawing in which a search result is exhibited in a floating layer in a method for performing network search at a browser side according to an embodiment of the invention;

FIG. 8 is a third effect drawing in which a search result is exhibited in a floating layer in a method for performing network search at a browser side according to an embodiment of the invention;

FIG. 9 shows schematically a block diagram of a computing device for performing a method for performing network search at a browser side according to the invention; and

FIG. 10 shows schematically a storage unit for retaining or carrying a program code implementing a method for performing network search at a browser side according to the invention.

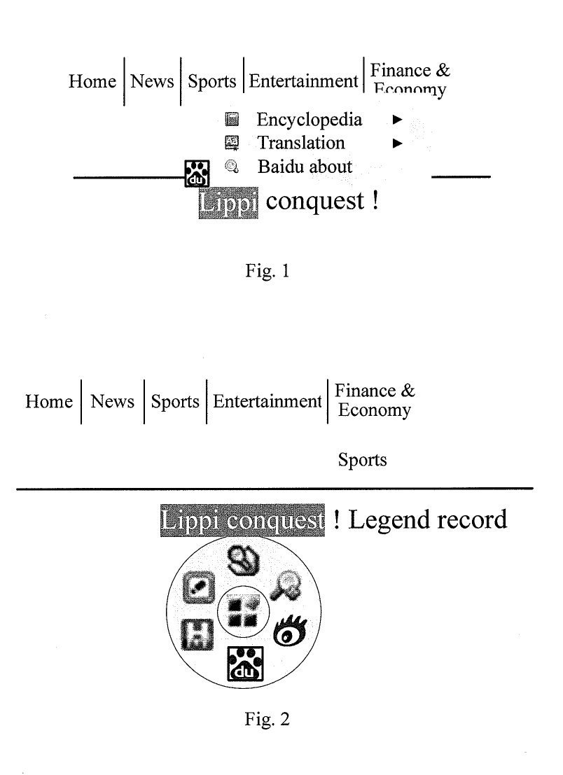

### DETAILED DESCRIPTION OF THE INVENTION

In the following the invention will be further described in connection with the drawings and the particular embodiments.

The algorithms and displays provided here are not inherently related to any specific computer, virtual system or other device. Various general-purpose systems may also be used with the teachings herein. According to the above description, the structure required for constructing such systems is obvious. In addition, the invention is not directed to any specific programming language. It should be understood that the content of the invention described herein may be carried out utilizing various programming languages, and that the above description for a specific language is for the sake of disclosing preferred embodiments of the invention.

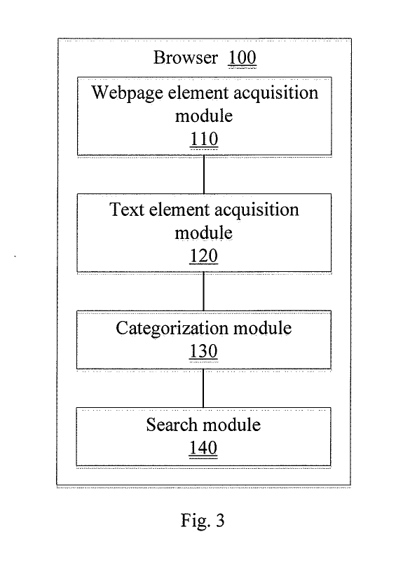

FIG. 3 is a schematic diagram of a browser 100 according to an embodiment of the invention. The browser 100 may generally comprise: a webpage element acquisition module 110, a text element acquisition module 120, a categorization module 130 and a search module 140.

In the above individual modules of the browser 100, the webpage element acquisition module 110 is configured to acquire a selected webpage element in a webpage; the text element acquisition module 120 is configured to pick out a text element in the selected webpage element; the categorization module 130 is configured to acquire a search category corresponding to the text element; and a search module 140 is configured to initiate a search request to a search engine interface corresponding to the search category, and display a search result returned by the search engine interface at the browser side.

There may be comprised multiple types of the selected webpage element acquired by the webpage element acquisition module 110, for example, picture, music, video, and word, etc. Each kind of webpage element corresponds to one or more search category. For the video, picture and music, the search target of a user is relatively clear, for example, a picture-typed webpage element corresponds to picture-typed search, a music-typed webpage element corresponds to music-typed search, and a video-typed webpage element corresponds to video-typed search. For a case in which search needs to be performed for the selected text element, since it may correspond to various search categories, a text webpage element needs to be picked out by the text element acquisition module 120, and a corresponding search category is determined by the categorization module 130.

The acquisition of a search category corresponding to the text element by the categorization module 130 may be implemented by utilizing multiple modes, for example, using a search category of which the frequency of use by the user is high, exploiting a mode of matching a keyword to determine a search category, determining a search category in combination with the webpage, or the like.

Therein, one mode is that the categorization module 130 is configured to count frequencies of use of various search categories of the browser 100, and take a search category of which the frequency of use is ranked higher as a search category corresponding to the text element. A search category which is used most frequently by the user is taken as a preferably used search category.

Another implementation mode of determining a search category is that the categorization module 130 is configured to extract text content in the text element; perform search keywords matching on the text content, wherein the search keywords are vocabularies categorized according to search categories which are preset at the browser side; and take a search category corresponding to a matched search keyword as a search category corresponding to the text element. The search keywords may be obtained by collation according to data of the network search, for example, the search category for the name of a singer may be a music category or an entertainment category, the search category for commodity name search is preferably a shopping category or a picture category, or the like. If the text content matches the collated search keyword, a search category corresponding to the search keyword may be used for search. The above keyword matching work may be done at the browser side.

Still another preferable implementation mode of determining a search category is that the categorization module 130 comprises a webpage information acquisition sub-module and a category matching sub-module, wherein the webpage information acquisition sub-module is configured to acquire webpage information of the webpage, and the category matching sub-module is configured to determine a search category corresponding to the text element according to the webpage information. The webpage information may comprise part or all of the following: a uniform resource locator of the webpage, a title of an article which the text element belongs to, context content of the text element, and a user tag of a user of the webpage.

In particular, a configuration of the category matching sub-module is to determine a content type of the webpage according to the uniform resource locator (URL for short) of the webpage, and determine a search category corresponding to the text element according to the content type of the webpage in combination with the title of the article and the context content. By analysis of the URL, it may be determined whether the webpage is a type of video website, news website, or picture website, etc., or an individual channel of a portal website, or the like, and according to the website type which the webpage belongs to in combination with the title and the context content, specifics of a search category may be obtained.

The category matching sub-module may further set information weights for multiple search categories determined by multiple modes, respectively, and adopt a mode similar to weight calculation and scoring to determine a search category. In this mode of use, the category matching sub-module is configured to perform matching calculation to obtain individual corresponding search categories according to the text content of the text element, the content type of the webpage, and the user tag, respectively; set information weights for calculation for the text content, the webpage information and the user tag, respectively; and perform weighted calculation on the search categories obtained by the matching calculation according to the information weights, to obtain a search category corresponding to the text element.

After the categorization module 130 determines a search category, the search module 140 may initiate a request to a search engine interface corresponding to the search category and display a search result. One mode of configuring the search module 140 is to perform word segmentation processing on the text element to obtain one or more search field; send the one or more search field to a search engine interface corresponding to the search category; and generate in the webpage a floating layer for exhibiting a search result, and load the search result in the floating layer. The word segmentation processing of the text element is to split a relatively long field into relatively short keywords according to grammatical habits, which avoids that a search result is missed due to the search conditions being too strict.

The word segmentation of the text element selected by the user and the determination of its search category may be done at the browser side, and then it is sent to a categorization search engine for search. Thereby, more accurate zoned word search may be realized, and the reaction speed of the search will improve the efficiency by intervention of the browser.

An embodiment of the invention further provides a method for performing network search at a browser side. The method for performing network search at a browser side may be carried out by any of the browsers 100 introduced in the above embodiments, to obtain a search result which better matches the selection of the user. In the following, the technical solution of the embodiment of the invention will be further explained by describing the method and its detailed flow.

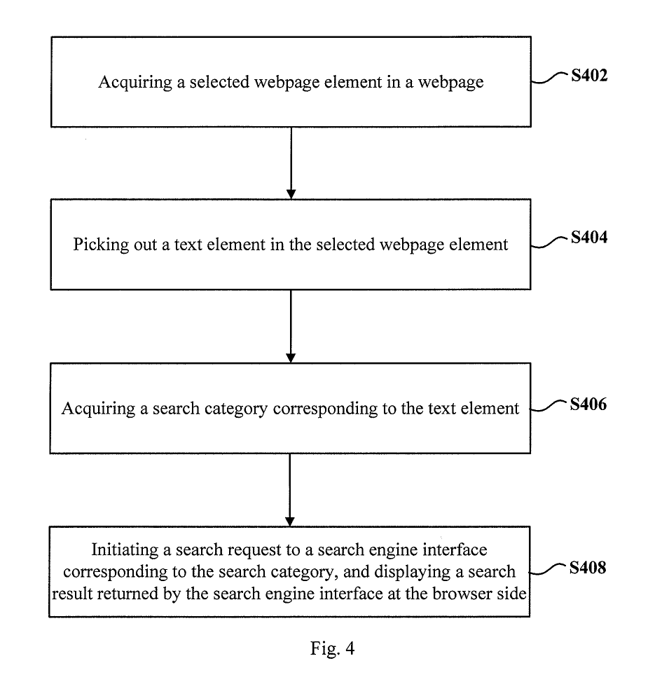

FIG. 4 is a schematic diagram of a method for performing network search at a browser side according to an embodiment of the invention. The method for performing network search at a browser side may generally comprise the following steps:

step S402, acquiring a selected webpage element in a webpage;

step S404, picking out a text element in the selected webpage element;

step S406, acquiring a search category corresponding to the text element; and

step S408, initiating a search request to a search engine interface corresponding to the search category, and displaying a search result returned by the search engine interface at the browser side.

There may be comprised multiple types of the selected webpage element acquired by the step S402, for example, picture, music, video, and word, etc. Each kind of webpage element corresponds to one or more search category. For the video, picture and music, the search target of a user is relatively clear, for example, a picture-typed webpage element corresponds to picture-typed search, a music-typed webpage element corresponds to music-typed search, and a video-typed webpage element corresponds to video-typed search. For a case in which search needs to be performed for the selected text element, it is necessary to perform subsequent steps to determine a search category. The implementation flow of the step S402 and the step S406 may be to acquire a webpage element in a page selected by a user; the acquisition of a webpage element may be implemented by the interface IHTMLSelectionObject, of which the flow may be to first obtain a pointer of the interface IHTMLSelectionObject according to the pointer IHTMLDocument2, then obtain the pointer ITxtRange, obtain selected html text content, and get selected text content.

The acquisition of a search category corresponding to the text element may be performed by utilizing multiple modes, for example, using a search category of which the frequency of use by the user is high, exploiting a mode of matching a keyword to determine a search category, determining a search category in combination with the webpage, or the like. In the following, various implementation modes of the step S406 will be introduced respectively.

An implementation flow of the step S406 is to count frequencies of use of various search categories of the browser, and take a search category of which the frequency of use is ranked higher as a search category corresponding to the text element. A search category determined as such is obtained by usage habits of a user, and the search category which is used most frequently by the user is loaded first.

Another implementation flow of the step S406 is to extract text content in the text element; perform search keywords matching on the text content, wherein the search keywords are vocabularies categorized according to search categories which are preset at the browser side; and take a search category corresponding to a matched search keyword as a search category corresponding to the text element. The matching of a search keyword is performed at the browser side, wherein search keywords are categorized in advance according to categories, for example, webpage, video, etc. Therein, the search keywords are obtained by collecting and collating network search data, and comprise common search keywords and their categories. If a search keyword is obtained by the matching, categorized search engine entries are displayed according to the matching result. If the matching is unsuccessful, all search entries may be displayed for selection by the user according to general default several search categories, namely, various search types may be loaded according to a preset order of search types. Table 1 shows a preset table of search types.

TABLE 1

| Search category | Keyword 1 | Keyword 2 | . . . |
|---|---|---|---|
| News search | Keyword A | Keyword B | |
| Music search | Keyword C | Keyword D | |
| Video search | Keyword E | Keyword F | |
| Encyclopedia search | Keyword G | Keyword H | |
| . . . | | | |

A corresponding search category may be obtained by utilizing the preset table of search keywords, and there may be comprised multiple search categories obtained correspondingly, for example, the search corresponding to the encyclopedia search may be Baidu encyclopedia, Wikipedia, 360 encyclopedia, etc.

Still another implementation flow of the step S406 may further comprise: acquiring webpage information of the webpage, and determining a search category corresponding to the text element according to the webpage information, wherein the webpage information may comprise any one or more of the following: a uniform resource locator URL of the webpage, a title of an article which the text element belongs to, context content of the text element, and a user tag of a user of the webpage. Therein, one mode of determining a search category corresponding to the text element according to the webpage information is to determine a content type of the webpage according to the uniform resource locator URL of the webpage, and determine a search category corresponding to the text element according to the content type of the webpage in combination with the title of the article and the context content.

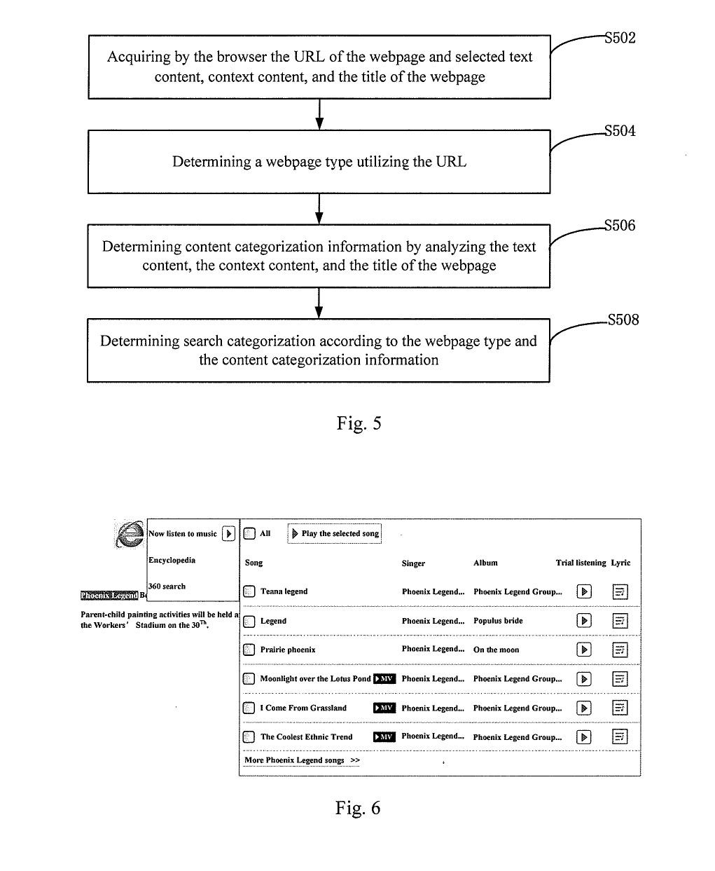

FIG. 5 is a flow block diagram of utilizing webpage information to determine a search category in a method for performing network search at a browser side according to an embodiment of the invention. As shown, a flow of utilizing webpage information to determine a search category comprises:

step S502, acquiring by the browser the URL of the webpage and text content of the selected text element, context content of the selected text element, and the title of an article which the text element belongs to;

step S504, determining a webpage type utilizing the URL;

step S506, determining content categorization information according to the text content of the selected text element, the context content of the selected text element, and the title of the article which the text element belongs to; and

step S508, determining search categorization according to the webpage type and the content categorization.

The steps S504 to S508 may be performed at the browser side, or also may be sent to a server side for implementation by the browser. When a server side is utilized to determine search categorization, the browser side combines the acquired word keyword, the URL of the current webpage and word related information such as the content title in the webpage content, etc. with the text content of the selected text element, packs them and sends them to the corresponding server side for search, wherein the server analyzes the type of the current URL, for example, a video website, a new website, a picture website, etc., or a categorized secondary website of mainstream portal websites, and such information may be extracted and judged from characteristic values of the URL, and combined with the title of the article where the zoned keyword is located or a context keyword to determine the categorization of a currently zoned word keyword. The categorization may also be done by employing a mode of matching a search keyword, wherein data statistics according to the network search is utilized to obtain a search keyword to be matched with the above categorization information to obtain a final search category.

For the selected text content, it may also be possible to utilize a matching strategy preset at the browser side to determine a search type according to the title of the current webpage, the subject matter of a text, etc. For example, if a keyword of “ [symbol] ” is clicked in a webpage reporting the basketball, it will be naturally judged to use news, webpage, video as a recommended search category.

A procedure of determining a search category may further set a user tag by counting categories of webpages browsed by a user in combination with category information of the browser user. For example, if webpages visited much by a user are a military channel and a film & TV channel, then tag keywords of the browser user are military and film & TV, and the military and film & TV search categories are provided with a high priority level in search categories provided by his zoned word search.

When determining a search category in the above, search categories determined by different factors may not be unified. In such a case, it may be possible to set information weights for calculation for search categories determined by different modes, respectively, to perform weight calculation, and take the search category with the highest score as a preferable search category, for example, perform matching calculation to obtain individual corresponding search categories according to the text content of the text element, the content type of the webpage, and the user tag, respectively; set information weights for calculation for the text content, the webpage information and the user tag, respectively; and perform weighted calculation on the search categories obtained by the matching calculation according to the information weights, to obtain a search category corresponding to the text element.

A specific example is to preset the weight for a search category judged according to the webpage content to be 5, the weight for a search category determined according to the title of the webpage to be 3, and the weight for a search category determined according to the user tag of the browser to be 1, perform weight superposition utilizing search categories determined by the above various modes, respectively, and take the search category with the highest weight value as a preferable search category.

A flow of initiating a search request to a search engine interface corresponding to the search category at the step S408 is to perform word segmentation processing on the text element to obtain one or more search field; and send the one or more search field to a search engine interface corresponding to the search category. The word segmentation processing of the text element is to split a relatively long field into relatively short keywords according to grammatical habits, which avoids that a search result is missed due to the search conditions being too strict.

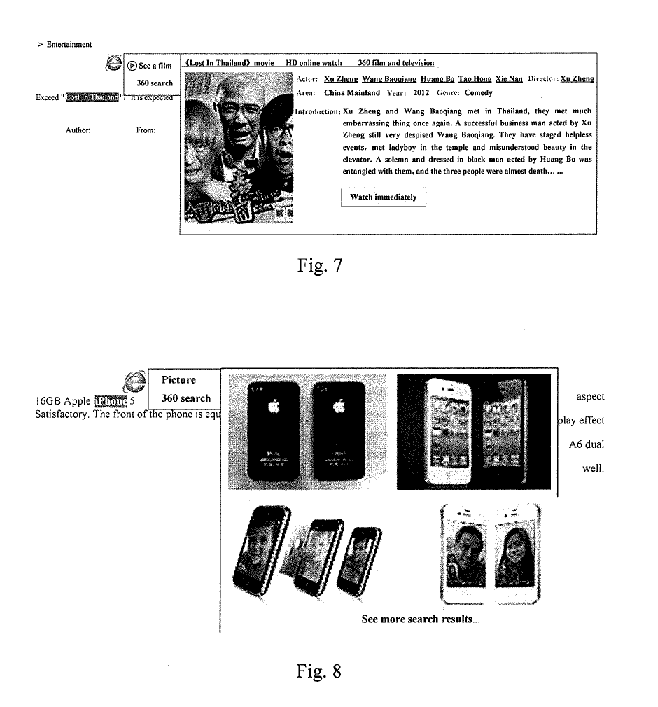

A flow of displaying the search result returned by the search engine interface at the browser side at the step S408 is to generate in the webpage a floating layer for exhibiting a search result, and load the search result in the floating layer. FIGS. 6, 7 and 8 are three effect drawings in which a search result is exhibited in a floating layer in a method for performing network search at a browser side according to an embodiment of the invention, respectively. Such a display method facilitates the user to quickly obtain the search result, and does not affect the user's browsing the original page, which achieves that the user is let to rapidly reach the content and acquire the search result quickly and accurately, and improves the efficiency of a search operation performed by the user when browsing a webpage.

It can be seen from the above effect drawings that by utilizing the browser and the method for network search provided by embodiments of the invention, the categorization of search matches content that needs to be searched, generally a search result that a user most wants to obtain, which meets the user's search needs, and improves the user's experiences.

By using the method for performing network search at a browser side and the browser provided by the embodiments, the search category is determined according to the text content in the selected webpage element, the search result displayed in the browser matches the search category needed by a user, thereby, the search result which more meets the user's expectations is obtained, intervention of the search procedure by the user is reduced, and the efficiency of the search operation performed by the user when browsing a webpage is improved.

Further, in the invention, an exhibition floating layer categorized according to the search category is generated in the page, and the search result is loaded in the floating layer, which can perform display according to an accurate categorization, facilitates the user to quickly obtain the search result, and does not affect the user's browsing the original page.

In the specification provided herein, a plenty of particular details are described. However, it can be appreciated that an embodiment of the invention may be practiced without these particular details. In some embodiments, well known methods, structures and technologies are not illustrated in detail so as not to obscure the understanding of the specification.

Similarly, it shall be appreciated that in order to simplify the disclosure and help the understanding of one or more of all the inventive aspects, in the above description of the exemplary embodiments of the invention, sometimes individual features of the invention are grouped together into a single embodiment, figure or the description thereof. However, the disclosed methods should not be construed as reflecting the following intention, namely, the claimed invention claims more features than those explicitly recited in each claim. More precisely, as reflected in the following claims, an aspect of the invention lies in being less than all the features of individual embodiments disclosed previously. Therefore, the claims complying with a particular implementation are hereby incorporated into the particular implementation, wherein each claim itself acts as an individual embodiment of the invention.

It may be appreciated to those skilled in the art that modules in a device in an embodiment may be changed adaptively and arranged in one or more device different from the embodiment. Modules or units or assemblies may be combined into one module or unit or assembly, and additionally, they may be divided into multiple sub-modules or sub-units or subassemblies. Except that at least some of such features and/or procedures or units are mutually exclusive, all the features disclosed in the specification (including the accompanying claims, abstract and drawings) and all the procedures or units of any method or device disclosed as such may be combined employing any combination. Unless explicitly stated otherwise, each feature disclosed in the specification (including the accompanying claims, abstract and drawings) may be replaced by an alternative feature providing an identical, equal or similar objective.

Furthermore, it can be appreciated to the skilled in the art that although some embodiments described herein comprise some features and not other features comprised in other embodiment, a combination of features of different embodiments is indicative of being within the scope of the invention and forming a different embodiment. For example, in the following claims, any one of the claimed embodiments may be used in any combination.

Embodiments of the individual components of the invention may be implemented in hardware, or in a software module running on one or more processors, or in a combination thereof. It will be appreciated by those skilled in the art that, in practice, some or all of the functions of some or all of the components in a browser according to individual embodiments of the invention may be realized using a microprocessor or a digital signal processor (DSP). The invention may also be implemented as a device or apparatus program (e.g., a computer program and a computer program product) for carrying out a part or all of the method as described herein. Such a program implementing the invention may be stored on a computer readable medium, or may be in the form of one or more signals. Such a signal may be obtained by downloading it from an Internet website, or provided on a carrier signal, or provided in any other form.

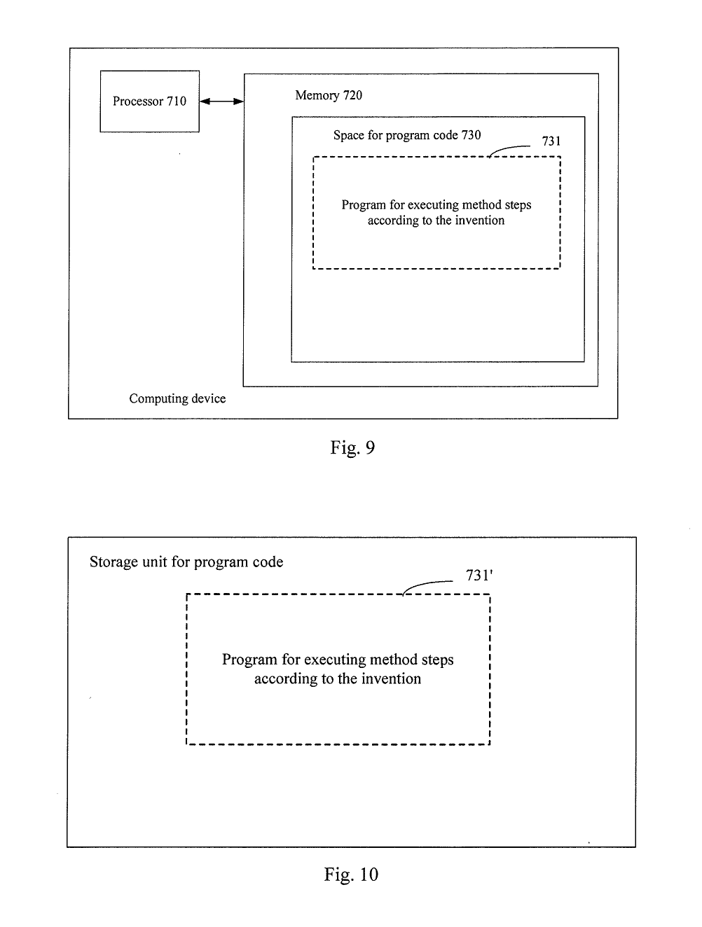

For example, FIG. 9 shows a computing device which may carry out a method for performing network search at a browser side according to the invention, for example, an application server, a personal computer, etc. The computing device traditionally comprises a processor 710 and a computer program product or a computer readable medium in the form of a memory 720. The memory 720 may be an electronic memory such as a flash memory, an EEPROM (electrically erasable programmable read-only memory), an EPROM, a hard disk or a ROM. The memory 720 has a memory space 730 for a program code 731 for carrying out any method steps in the methods as described above. For example, the memory space 730 for a program code may comprise individual program codes 731 for carrying out individual steps in the above methods, respectively. The program codes may be read out from or written to one or more computer program products. These computer program products comprise such a program code carrier as a hard disk, a compact disk (CD), a memory card or a floppy disk.

Such a computer program product is generally a portable or stationary storage unit as described with reference to FIG. 10. The storage unit may have a memory segment, a memory space, etc. arranged similarly to the memory 720 in the computing device of FIG. 9. The program code may for example be compressed in an appropriate form. In general, the storage unit comprises a computer readable code 731′, i.e., a code which may be read by e.g., a processor such as 710, and when run by a computing device, the codes cause the computing device to carry out individual steps in the methods described above.

“An embodiment”, “the embodiment” or “one or more embodiments” mentioned herein implies that a particular feature, structure or characteristic described in connection with an embodiment is included in at least one embodiment of the invention. In addition, it is to be noted that, examples of a phrase “in an embodiment” herein do not necessarily all refer to one and the same embodiment.

It is to be noted that the above embodiments illustrate rather than limit the invention, and those skilled in the art may design alternative embodiments without departing the scope of the appended claims. In the claims, any reference sign placed between the parentheses shall not be construed as limiting to a claim. The word “comprise” does not exclude the presence of an element or a step not listed in a claim. The word “a” or “an” preceding an element does not exclude the presence of a plurality of such elements. The invention may be implemented by means of a hardware comprising several distinct elements and by means of a suitably programmed computer. In a unit claim enumerating several apparatuses, several of the apparatuses may be embodied by one and the same hardware item. Use of the words first, second, and third, etc. does not mean any ordering. Such words may be construed as naming.

Furthermore, it is also to be noted that the language used in the description is selected mainly for the purpose of readability and teaching, but not selected for explaining or defining the subject matter of the invention. Therefore, for those of ordinary skills in the art, many modifications and variations are apparent without departing the scope and spirit of the appended claims. For the scope of the invention, the disclosure of the invention is illustrative, but not limiting, and the scope of the invention is defined by the appended claims.

1. A method for performing network search at a browser side, comprising:
acquiring a selected webpage element in a webpage;
picking out a text element in the selected webpage element;
acquiring a search category corresponding to the text element; and
initiating a search request to a search engine interface corresponding to the search category, and displaying a search result returned by the search engine interface at the browser side.

2. The method as claimed in claim 1, wherein the acquiring a search category corresponding to the text element comprises:
counting frequencies of use of various search categories of a browser, and taking a search category of which the frequency of use is ranked higher as a search category corresponding to the text element.

3. The method as claimed in claim 1, wherein the acquiring a search category corresponding to the text element comprises:
extracting text content in the text element;
performing search keywords matching on the text content, wherein the search keywords are vocabularies categorized according to search categories which are preset at the browser side; and
taking a search category corresponding to a matched search keyword as a search category corresponding to the text element.

4. The method as claimed in claim 1, wherein the acquiring a search category corresponding to the text element comprises:
acquiring webpage information of the webpage, the webpage information comprising any one or more of the following: a uniform resource locator of the webpage, a title of an article which the text element belongs to, context content of the text element, and a user tag of a user of the webpage; and
determining a search category corresponding to the text element according to the webpage information.

5. The method as claimed in claim 4, wherein the determining a search category corresponding to the text element according to the webpage information comprises:
determining a content type of the webpage according to the uniform resource locator of the webpage, and determining a search category corresponding to the text element according to the content type of the webpage in combination with the title of the article and the context content.

6. The method as claimed in claim 5, wherein the determining a search category corresponding to the text element according to the webpage information comprises:
performing matching calculation to obtain individual corresponding search categories according to the text content of the text element, the content type of the webpage, and the user tag, respectively;
setting information weights for calculation for the text content, the webpage information and the user tag, respectively; and
performing weighted calculation on the search categories obtained by the matching calculation according to the information weights, to obtain a search category corresponding to the text element.

7. The method as claimed in claim 1, wherein initiating a search request to a search engine interface corresponding to the search category comprises:
performing word segmentation processing on the text element to obtain one or more search field; and
sending the one or more search field to a search engine interface corresponding to the search category.

8. The method as claimed in claim 1, wherein displaying a search result returned by the search engine interface at the browser side comprises:
generating in the webpage a floating layer for exhibiting a search result, and loading the search result in the floating layer.

9. A device for performing network search at a browser side, comprising:
a memory having instructions stored thereon; and
at least one processor configured to execute the instructions to perform operations for performing network search at a browser side, the operations comprising:
acquiring a selected webpage element in a webpage;
picking out a text element in the selected webpage element;
acquiring a search category corresponding to the text element; and
initiating a search request to a search engine interface corresponding to the search category, and displaying a search result returned by the search engine interface at the browser side.

10. The device as claimed in claim 9, wherein acquiring a search category corresponding to the next element comprises:
counting frequencies of use of various search categories of a browser, and taking a search category of which the frequency of use is ranked higher as a search category corresponding to the text element.

11. The device as claimed in claim 9, wherein acquiring a search category corresponding to the text element comprises:
extracting text content in the text element; performing search keywords matching on the text content, wherein the search keywords are vocabularies categorized according to search categories which are preset at the browser side; and taking a search category corresponding to a matched search keyword as a search category corresponding to the text element.

12. The device as claimed in claim 9, wherein acquiring a search category corresponding to the text element comprises:
acquiring webpage information of the webpage, the webpage information comprising any one or more of the following: a uniform resource locator of the webpage, a title of an article which the text element belongs to, context content of the text element, and a user tag of a user of the webpage; and
determining a search category corresponding to the text element according to the webpage information.

13. The device as claimed in claim 12, wherein determining a search category corresponding to the text element according to the webpage information comprises:
determining a content type of the webpage according to the uniform resource locator of the webpage, and determining a search category corresponding to the text element according to the content type of the webpage in combination with the title of the article and the context content.

14. The device as claimed in claim 12, wherein determining a search category corresponding to the text element according to the webpage information comprises:
performing matching calculation to obtain individual corresponding search categories according to the text content of the text element, the content type of the webpage, and the user tag, respectively; setting information weights for calculation for the text content, the webpage information and the user tag, respectively; and performing weighted calculation on the search categories obtained by the matching calculation according to the information weights, to obtain a search category corresponding to the text element.

15. The device as claimed in claim 9, wherein initiating a search request to a search engine interface corresponding to the search category, and displaying a search result returned by the search engine interface at the browser side comprises:
performing word segmentation processing on the text element to obtain one or more search field; sending the one or more search field to a search engine interface corresponding to the search category; and generating in the webpage a floating layer for exhibiting a search result, and loading the search result in the floating layer.

16. (canceled)

17. A non-transitory computer readable medium having instructions stored thereon that, when executed by at least one processor, cause the at least one processor to perform operations for performing network search at a browser side, comprising:
acquiring a selected webpage element in a webpage;
picking out a text element in the selected webpage element;
acquiring a search category corresponding to the text element; and
initiating a search request to a search engine interface corresponding to the search category, and displaying a search result returned by the search engine interface at the browser side.
